(19) United States
(12) Patent Application Publication
(10) Pub. No.: US 2019/0329157 A1
(43) Pub. Date: Oct. 31, 2019

(54) DEVICE AND METHOD FOR EXTRACTING AT LEAST ONE GAS DISSOLVED IN A LIQUID

(71) Applicant: CENTRE NATIONAL DE LA RECHERCHE SCIENTIFIQUE, Paris (FR)

(72) Inventors: Jack TRIEST, LA TRONCHE (FR); Jérôme CHAPPELLAZ, SAINT-EGREVE (FR); Roberto GRILLI, FONTAINE (FR)

(21) Appl. No.: 16/475,958

(22) PCT Filed: Jan. 3, 2018
(86) PCT No.: PCT/EP2018/050141

§ 371 Date: Jul. 3, 2019

(30) Foreign Application Priority Data
Jan. 4, 2017 (FR) 17 50063

(51) Int. Cl. B01D 19/00; G01N 7/10; G01N 21/3504

(52) U.S. Cl. CPC B01D 19/0031; G01N 21/3504; G01N 7/10; B01D 19/0063

(57) ABSTRACT

A frozen composition based on yoghurt and fruit, containing: one or more fruits in pureed and/or juice form, representing from 30 to 49% or from 49.1 to 220% of the total weight of the composition, as fruit equivalent, from 51 to 70% by weight of yoghurt, and optionally one or more added sugars and/or other ingredients. A process for the manufacture of this composition, its use for the manufacture of a frozen dessert, and a process for the manufacture of the dessert, by grinding and optionally aerating the composition are also disclosed.

### BACKGROUND OF THE INVENTION

### Field of the Invention

The present invention relates to a device and a method for extracting at least one gas dissolved in a liquid. The present invention relates in particular to analyzing at least one parameter of at least one gas dissolved in a liquid.

### Description of the Related Art

It is already known to extract gases dissolved in a liquid, in particular for the purpose of analyzing at least one of the parameters of the dissolved gas. This type of extraction is implemented in particular in order to know one or more parameters of a gas dissolved in an aqueous environment, such as for example a lake, a sea or an ocean. The concentration of at least one dissolved gas of interest is generally sought. Typically, the purpose is to determine the influence for example of pollution on the environment or to control an offshore oil or gas installation by assessing the concentration of the gas or gases of interest such as for example methane, ethane or carbon dioxide.

Different devices are already known for this purpose, including in particular the device described in patent application EP 2629082 from Contros Systems & Solutions GmbH. This patent application relates to a device for detecting a partial pressure and method for operating the same. The gas of interest can be extracted from the surrounding liquid by passing through a membrane and comprises a circuit for circulating the gas in a closed loop at a pressure close to atmospheric pressure, for example using a pump, the gas being circulated through equipment for detecting at least one parameter of the gas previously dissolved in the surrounding liquid. This device operates with a reservoir of reference gas making it possible to calibrate the measurement. Calibration with a reference gas which flows in a closed loop through the measurement device without gas exchange with the liquid in contact with the membrane is suggested. However, this device has the major drawback of a very long response time. The device described in patent application WO 2015/110507 from Franatech is also known. This patent application describes a module for capturing a gas dissolved in a liquid, and a measurement device. The capture module comprises a membrane mounted in a housing in order to capture the gas dissolved in the liquid. The purpose of this device is to improve the exchange surface and differently position the inlet pipe such that the gas passing through the membrane is no longer necessarily guided perpendicular thereto, and such that it can be guided towards an inlet pipe having a more significant exchange surface with the membrane. This device makes it possible in particular to circulate the gas both in parallel and perpendicular to the plane of the support element, thus making it possible to improve the circulation of the gas and the efficiency of the capture module. However, once again the response time of the device requires improvement.

The devices currently known have a response time of the order of tens of minutes, or more.

Patent application US 2006/0070525, from Pro-Oceanus, describes a gas separation device for extracting a gas dissolved in a fluid. The device comprises a membrane and a support device of the helical or tubular type serving to support a membrane. In order to improve the rate of equilibration at the gas/liquid interface, this application describes the use of forced circulation of the external fluid adjacent to the tubular membrane at its outer surface.

The instruments available on the market only allow very targeted studies of traces of methane and carbon dioxide dissolved in an ocean. The instruments do not offer any possibility of being able to trace profiles (vertical and horizontal) of these gases in the oceans and in practice are only suitable for strong concentrations and are not able to resolve the background noise values. These instruments do not offer a multi-species measurement (several components simultaneously), or a measurement of the isotope ratios.

There is also a demand in the industrial environment, in particular for the chemical, biochemical, biological, oil or gas industry, to know the concentration of one or more gases dissolved in a liquid.

### SUMMARY OF THE INVENTION

Thus, the purpose of the present invention is to improve the response time of a device for extracting at least one gas dissolved in a liquid in order to make it possible in particular to rapidly analyze at least one parameter of one or more gases dissolved in the liquid.

More particularly, the purpose of the present invention is to provide a device having a response time that is less than a minute and preferably less than 30 seconds. In particular, a purpose of the invention is to provide a device making it possible to very rapidly transfer the dissolved gas or gases extracted from the liquid to an instrument for analyzing at least one of their parameters.

A purpose of the present invention is to provide a device for extracting at least one gas dissolved in a liquid in order to analyze a trace gas.

Thus, a purpose of the present invention is also to provide a device for extracting at least one dissolved gas having a high resolution and/or sensitivity in order to measure a low concentration of gas dissolved in a liquid.

A purpose of the present invention is also to provide a device for extracting at least one dissolved gas having a high resolution and/or sensitivity in order to measure a variable concentration of gas dissolved in a liquid, this concentration being able to be low as well as high, and above all to optimize the measurement depending on the concentration of gas.

A purpose of the present invention is to provide an autonomous device for measuring at least one parameter of at least one gas dissolved in a liquid.

A purpose of the present invention is also to provide a measurement device with a high spatial and temporal resolution, preferably with an excellent sensitivity, in order to measure in particular the concentration of at least one gas dissolved in a liquid.

A purpose of the present invention is also to provide a device making it possible to analyze or study at least one parameter of a gas dissolved in a liquid, in particular in the context of an environmental study or control of a plant, for example a chemical, biochemical, biological, oil or gas plant.

The present inventors have discovered that a method or a device as described according to the present invention makes it possible to meet at least one of the technical problems mentioned above. In particular, the present invention makes it possible to improve the response time of a device for extracting at least one gas dissolved in a liquid.

The present invention relates in particular to a method for measuring, preferably continuously, the concentration or the partial pressure of at least one gas dissolved in a liquid, comprising bringing a gas/liquid separation device comprising at least one membrane into contact with a liquid the concentration or partial pressure of at least one dissolved gas of which is to be measured, separating at least one gas dissolved in the liquid through the membrane or membranes of the gas/liquid separation device, measuring the diffusion and/or permeation stream through the membrane or membranes, and calculating the concentration of gas previously dissolved in the liquid based on the diffusion and/or permeation stream.

The present invention also relates in particular to a device 1, 101 for extracting at least one gas dissolved in a liquid, said device comprising (i) at least one gas-liquid separation membrane 3, 103, (ii) at least one liquid circuit (LC) 5, 105 for at least one liquid (L) comprising a dissolved gas, said liquid circuit (LC) 5, 105 being arranged in order to bring the liquid (L) into contact with at least one gas-liquid separation membrane 3, 103, the liquid being in contact with the outer surface 31, 133 of the membrane 3, 103, (iii) a first gas circuit (GC1) 10, 110 for circulating at least one inert gas (Gᵢ), the first gas circuit (GC1) being in contact with the inner surface 32, 132 of the membrane 3, 103, the first circuit (GC1) 10, 110 not comprising gas (GO separated from the liquid (L) upstream of the membrane 3, 103, and (iv) a second gas circuit (GC2) 20, 120 for circulating inert gas (Gᵢ) and at least one gas (GO separated from the liquid (L), the second circuit (GC2) 20, 120 being in contact with the inner surface 32, 132 of the membrane (3, 103) and communicating with the first gas circuit (GC1) 10, 110, the second gas circuit (GC2) 20, 120 circulating at least one gas (GO separated from the liquid towards a device 50, 150 for measuring at least one parameter of the gas (GO separated from the liquid, said second gas circuit 20, 120 being in communication with at least one device (50, 150) for measuring at least on parameter of the gas (GO separated from the liquid.

By “liquid” is meant a liquid environment in the broad sense, i.e. capable of containing particles in suspension and/or one or more non-dissolved gases, and capable of comprising one or more liquid phases.

Advantageously, the method according to the present invention is implemented with a device as defined according to the present invention.

According to an embodiment, the method comprises maintaining a zero or insignificant concentration of gas the parameter of which is to be measured at the surface of the membrane or membranes on the permeate side and controlling and/or measuring at least one secondary parameter, preferably all of the secondary parameters, significantly influencing the permeation and/or diffusion through the membrane or membranes. Similarly, the device can advantageously comprise a device for maintaining a zero or insignificant concentration at the surface of the membrane or membranes on the permeate side and one or more devices for controlling and/or measuring at least one secondary parameter, preferably all of the secondary parameters, significantly influencing the permeation and/or diffusion through the membrane or membranes.

Advantageously, by maintaining a zero or insignificant concentration, the response of a device for measuring the concentration of at least one gas dissolved in a liquid is no longer dependent on the concentration reaching equilibrium; on the contrary, it depends only on (and is preferably limited to only) the permeation time through the membrane or membranes and the time for the sample of gas to be analyzed to reach the measurement device.

Advantageously, according to a variant, the concentration gradient between the gas dissolved in the liquid and the gas on the permeate side of the membrane or membranes represents the main diffusion and/or permeation force.

According to a variant, measurement of the concentration or the partial pressure of at least one dissolved gas by a measurement device 50, 150 is carried out by subtracting the value of the inert gas flow rate from the value of the total flow rate of the gas sent to the measurement device 50, 150.

Advantageously, according to a variant, the device is calibrated with regard to one or more secondary parameters to be controlled or measured. Preferably this calibration is carried out before measuring the parameter or parameters of interest.

Preferably, a secondary parameter to be controlled or measured is selected from the group consisting of: the liquid stream passing through the membrane, the geometry of which is preferably optimized in order to maintain a constant stream and boundary layer conditions independent of the liquid stream conditions around the liquid inlet or outlet; the salinity; the temperature of the liquid; the temperature of the membrane; the total pressure on the liquid side of the membrane; and/or the concentration of one or more other dissolved gases or elements present in the liquid (such as for example oxygen, iron etc.).

According to a specific embodiment, measurement of the diffusion and/or permeation stream through the membrane or membranes is carried out by maintaining a zero or insignificant concentration at the surface of the membrane or membranes on the permeate side, causing a stream of inert gas to pass over the surface on the permeate side, said stream of inert gas flowing in an open circuit.

Advantageously, the device according to the present invention avoids the need to wait for equilibrium of both sides of the membrane for the parameter to be analyzed, and in particular equilibrium of the concentration of gas extracted from the liquid.

Advantageously, the first gas circuit and/or the second gas circuit of the device according to the present invention is an open circuit. By “open circuit” is meant specifically that the gas, and more specifically the gas extracted from the liquid, does not flow in a closed loop in the circuit in question, but is evacuated to the outside of the device or a vessel for storage and optionally reprocessing or directed from the first to the second circuit. If the second circuit comprises returning inert gas to the first circuit, any trace of dissolved gas extracted from the liquid must have been trapped, destroyed, eliminated or transformed in a suitable device before the stream of inert gas comes into contact with the membrane. Thus, according to a variant, the device 1, 101 comprises returning the inert gas Gᵢ from the second gas circuit GC2 to the first gas circuit GC1, preferably with a trap for the gas G_{L} separated from the liquid and at least one parameter of which is to be measured, or a device for separating the gas G_{L} separated from the liquid and at least one parameter of which is to be measured, from the inert gas Gᵢ, preventing or limiting the circulation of gas G_{L} separated from the liquid and at least one parameter of which is to be measured in the first gas circuit GC1 and above all over the portion of the membrane intended to be in contact with the inert gas only. The first gas circuit can comprise a gas extracted from the liquid which does not interfere significantly with the analysis of the analyzed parameter and which is not the gas G_{L} at least one parameter of which is to be analyzed.

Advantageously, the device according to the present invention does not require waiting for equilibrium of the concentrations on both sides of the gas-liquid separation membrane. The response time of the device according to the present invention can advantageously be cut significantly with respect to prior devices, typically from an analysis taking 10 to 15 minutes, or even over an hour according to the prior art, to an analysis in several seconds or tens of seconds according to the invention.

Liquid Circuit

According to a preferred embodiment, the liquid circuit is an open circuit. The liquid flow is carried out advantageously so as to allow control of the liquid stream in order to ensure a constant and optimal extraction of the dissolved gas to be extracted, through the gas/liquid separation membrane or membranes. By “optimal” is meant that the boundary layers and turbulence are limited and the liquid stream is not influenced by the changes of liquid stream outside the device, such as for example the current of the liquid or the pressure of the liquid.

Advantageously, according to an embodiment, the liquid circuit comprises a liquid circulation pump. Advantageously, the liquid circulation pump makes it possible to control the flow rate of the liquid stream in the liquid circuit. In particular, a liquid circulation pump advantageously makes it possible to optimize the diffusion of gas dissolved in the liquid through a gas/liquid separation membrane. The liquid stream is such that the boundary layers are avoided or minimized. Advantageously, turbulence of the liquid stream is avoided or minimized.

Advantageously, the device is sealed to liquid in the part internal to the membrane and comprising a gas flow. Advantageously, only the outer part of the membrane is in contact with a liquid. The external liquid can be under any pressure whatever. According to an embodiment, the external liquid is under high pressure. Typically it can be an oil or a deep-water aqueous solution, such as for example from the floor of an ocean, a sea or a lake, or an oily extract from terrestrial or subaquatic soil. According to a variant, the liquid is the liquid from an industrial reactor, for example from a chemical reaction and/or a reaction involving living matter. By “living matter” is meant the presence of one or more living organisms. Typically in a bioreactor, it can be microorganisms involved in the production of one or more compounds of interest.

According to a preferred variant, in order to avoid measurement disturbances and fluctuations, the liquid stream has a constant flow rate in the liquid circuit. This constant flow rate can be imposed and optionally regulated by a pump.

According to a variant, the flow rate of the liquid stream can be controlled with respect to the liquid stream entering the device according to the invention which can for example vary depending on a current, the displacement of the device in the liquid, or other turbulence of the liquid environment. The inlet and the outlet are arranged so that a change of the external liquid stream does not affect the stream passing through the membrane. The pump is advantageously not affected by the inlet pressure.

First Gas Circuit

According to a variant, the device 1, 101 comprises a reservoir 70, 170 of inert gas supplying the first gas circuit (GC1) 10, 110.

The reservoir 70, 170 of inert gas can be internal or external to the device 1, 101, i.e. for example situated in the same casing or outside.

According to a variant, the reservoir 70, 170 is in communication with a non-return valve allowing the filling of the reservoir 70, 170 under high pressure, in general from 10 to 100 bar, and typically at approximately 40 bar.

According to a preferred variant, the first gas circuit comprises inert gas only. The inert gas can be optimized and depends on the measurement to be carried out.

More precisely, and advantageously, the first gas circuit, and in particular the inert gas, does not comprise gas extracted from the liquid. Even more advantageously, the first gas circuit, in particular the inert gas, has no effect on the measured parameter or parameters of the gas separated from the liquid.

Advantageously, the stream of inert gas is continuous, preferably during the extraction of the gas from the liquid and the measurement of at least one of their parameters.

The stream of inert gas is advantageously selected in order to optimize the extraction of the dissolved gas. The stream of inert gas advantageously has a flow rate that is non-zero, and more advantageously greater than 1.0 Ncm³/mn, preferably greater than 1.2 Ncm³/mn and more preferably greater than 1.5 Ncm³/mn. According to a particular embodiment, the stream of inert gas ranges from 1.5 to 3 Ncm³/mn. According to a particular embodiment, the stream of inert gas is from 5 to 20 Ncm³/mn.

The gas stream of the first gas circuit is optimized depending on the response time sought or imposed by an instrument for measuring at least one parameter of the gas previously dissolved in the liquid. According to an advantageous embodiment, the flow rate of the stream of inert gas of the first gas circuit depends on the concentration of gas extracted from the liquid in the inert gas sought. Thus according to a variant, the flow rate of the stream of inert gas depends on the concentration or the volume of gas dissolved in the liquid. Advantageously, the flow rate of the stream of inert gas is optimized in order to detect at least one parameter of the gas dissolved in the liquid. It was fortuitously discovered that such a flow rate of the stream of inert gas makes it possible to reduce very significantly the response time of an instrument for measuring at least one parameter of the gas dissolved in the liquid passing through the separation membrane. The concentration of the extracted gas is close to a zero concentration at the inner surface 32, 132 of the membrane. Thus, it is no longer necessary to wait for equilibrium. This advantageously makes it possible to operate the device regardless of the concentration of gas dissolved in the liquid.

According to a particular embodiment, the flow rate of inert gas in the first gas circuit makes it possible to control the dilution of the gas extracted from the liquid in the second gas circuit.

Thus, advantageously, in the method according to the invention, the stream of inert gas is controlled by a gas flow rate regulator in order to control the dilution of the sample of gas separated from the liquid and optimize the measurement of the diffusion and or permeation stream.

According to a preferred embodiment, the first gas circuit is in an open circuit and supplies the second gas circuit with inert gas. More precisely, the first gas circuit comprises an inlet opening onto an inert gas vessel, preferably pressurized, i.e. at a pressure greater than the pressure of the inert gas in the first gas circuit.

According to a variant, the inert gas vessel is situated outside the extraction device.

According to a variant, the inert gas vessel is situated inside the extraction device.

Advantageously, the inert gas vessel comprises a non-return valve in order to easily fill the vessel with inert gas.

According to an embodiment, the pressure in the inert gas vessel ranges from 10 to 100 bar, for example from 20 to 60 bar and for example from 30 to 50 bar, and for example is even approximately 40 bar.

Advantageously, the first gas circuit comprises a pressure reducing valve. In particular, the first gas circuit can comprise a gas-stream controller, advantageously controlling and regulating the flow rate in the first gas circuit, preferably once reduced by the pressure reducing valve.

According to an embodiment, upstream of the pressure reducing valve, the pressure of the inert gas is comprised between 10 and 100 bar, for example from 20 to 60 bar and for example from 30 to 50 bar, and for example is even approximately 40 bar. Preferably, the gas stream is controlled after the pressure reducing valve.

According to an embodiment, downstream of the pressure reducing valve, the pressure of the inert gas is less than the pressure upstream of the pressure reducing valve, for example in particular for the good operation of the gas stream controller for the inert gas, and for example comprised between 0.01 and 5 bar, for example between 0.01 and 0.5 bar, and for example between 0.02 and 0.1 bar.

The flow rate of the gas stream in the first gas circuit is typically of the order of 0.1 to 100 Ncm³/mn (SCCM—standard cubic centimetres per minute) and for example from 1 to 10 Ncm³/mn, and ideally from 1 to 5 Ncm³/mn.

According to an advantageous variant, the first gas circuit 10, 110 comprises a gas stream regulator 175, for example in the form of a pressure regulator and/or a gas flow rate regulation device, advantageously optimizing the response time and the concentration of the gas at least one parameter of which is to be measured in the measurement device 50, 150.

Advantageously, the gas stream regulator 175 controls the dilution of the gas separated from the liquid and optimizes the measurement of the diffusion stream by the measurement device (50, 150).

Advantageously, the gas stream regulator 175 controls the quantity of gas circulating at the inner surface 32, 132 of the membrane (permeate side).

Advantageously, the stream of inert gas circulating in the first gas circuit and in contact with the membrane or membranes 3, 103 makes it possible to create a very weak concentration, preferably close to zero of gas extracted from the liquid, in particular at the inner surface 32, 132 of the separation membrane 3, 103. Advantageously, the gas diffusion of the gas extracted from the liquid through the membrane makes it possible to optimize the response time in order to know the parameter or parameters analyzed.

According to a variant, the stream of inert gas is constant.

According to a variant, the stream of inert gas is fixed or varies in order to dilute the gas G_{L} separated from the liquid in the stream of the second gas circuit GC2, and in particular in order to adapt the flow rate of gas from the second gas circuit to the operating range of the measurement device 50, 150.

Advantageously, the flow rate of gas of the second gas circuit is regulated in order to optimize the measurement by the measurement device 50, 150.

The inert gas can be a gas mixture. Typically, it can be air, nitrogen, oxygen, argon or another inert gas for the analysis, i.e. which does not disturb the analysis of the parameter or parameters analyzed on the gas or gases extracted from the liquid.

Advantageously, the flow rate of inert gas in contact with the inner surface of the membrane makes it possible to minimize the concentration of gas extracted from the liquid at the inner surface of the membrane and maximize the diffusion stream through the membrane and to no longer be dependent on the equilibrium of the concentration or partial pressure of the extracted gas on both sides of the membrane.

Advantageously, the device according to the present invention allows a response time of less than a minute, typically less than 30 seconds, and in particular of the order of 15 seconds.

Second Gas Circuit

According to an embodiment, the second gas circuit is an open circuit. According to a variant, when the gas leaves the pump 140, it can be stored in a reservoir or used for further analysis.

According to an embodiment, the second gas circuit is a closed circuit. Such a closed circuit variant comprises removing from the gas circuit at least one parameter of which is to be measured, for example for subsequent analysis or for an autonomous device. According to a specific variant, the device 1, 101 comprises returning the inert gas Gᵢ, from the second gas circuit GC2 to the first gas circuit GC1, preferably with a trap for the gas G_{L} that is separated from the liquid, or a device for the separation of the gas G_{L} separated from the liquid of the inert gas Gi, preventing or limiting the circulation of gas G_{L}, separated from the liquid, in the first gas circuit GC1. According to an embodiment, returning the gas can take place at the level of the first gas circuit GC1 downstream of the pressure reducing valve 171 since it will already be at a reduced pressure with respect to the reservoir 170 for storing inert gas. It is possible to use a device operating at high temperature (for example 1000° C.) or cold or a chemical trap for eliminating or trapping the unwanted species in the stream of inert gas, and in particular in order to eliminate or trap the gas or gases at least one parameter of which is to be measured.

According to a variant, the inert gas is thus recycled after separation of the species to be analyzed and the reservoir 170 and the pressure reduction device 171 are not used.

According to a variant, the gas of the first gas circuit is thus not supplied from the reservoir 170, but in a closed loop. This variant allows continuous use without being dependent on the quantity of gas stored in a reservoir 170 or the storage capacity of the reservoir 200.

According to an embodiment, the second gas circuit 20, 120 comprises a device for measuring the gas stream 180. Advantageously, the device for measuring the gas stream 180 measures the flow rate of the total stream (CG1+G_{L}). The device for measuring the gas stream 180 is positioned preferably between the membrane 3, 103 and the measurement device 50, 150, preferably in order to measure the total flow rate of gas, including the gas separated from the liquid of interest, collected, typically, by subtracting the flow rate of inert gas from the flow rate measured. According to a variant, the second gas circuit 1, 120 comprises a device 140 for driving the gas separated from the liquid, for example a pump.

Advantageously, the second gas circuit 20, 120 comprises a device for measuring the gas stream 180, for example in the form of a device for measuring pressure and/or a device for measuring the flow rate of gas, advantageously making it possible to know or estimate the flow rate of gas extracted from at least one parameter to be measured in the measurement device 50, 150.

According to a preferred variant, the second gas circuit is arranged so as to convey the gas as quickly as possible to the measurement device.

According to an embodiment, the second gas circuit comprises a vacuum pump in order to create a pressure drop downstream of the membrane and preferably downstream of the measurement device 50, 150.

According to a variant, the gas circulating in the measurement device 50, 150 is dry. Advantageously the dry gas makes it possible to limit the humidity in the measurement device 50, 150 and in the pump 140.

By way of example, the gas can be dried by a Nafion® membrane or a silica cartridge 160.

Advantageously, the second gas circuit comprises a device for drying the gas contained in the second gas circuit. According to a variant, the device for drying the gas is situated upstream of the measurement device. According to another variant, the device for drying the gas is situated downstream of the measurement device and preferably upstream of any optional circulation pump situated downstream of the measurement device, for example a vacuum pump. Thus, advantageously, the gas circulating downstream of the drying device in the second gas circuit is dry or substantially dry, i.e. it contains a limited quantity of water in vapour form. According to a variant, the drying device is mounted in series on the second gas circuit.

According to a variant, the device for drying the gas comprises or is constituted by a permeation membrane selective for water vapour. According to a variant, the device for drying the gas comprises or is constituted by a silica cartridge.

According to a variant, the drying system comprises a permeation membrane selective for water vapour, preferably comprising a counterflow gas stream circuit, driving for example the spent water vapour towards a gas reservoir.

According to an embodiment, after having been transmitted to the measurement device 50, 150, the gas is sent to a storage reservoir 200, which can be outside the device 1, 101, for example for subsequent separate analysis or in order to optimize the volume of the device 1, 101.

Membrane

A membrane advantageously makes it possible to separate at least one gas from a liquid. According to a variant, the membrane makes it possible to separate several gases present in a liquid. According to a variant, the membrane is selective for separating one or more from among several gases present in a liquid.

According to a variant, the device 1, 101 comprises at least two gas-liquid separation membranes (M1; M2) 3, 103 placed facing one another, preferably an inlet of the second gas circuit (GC2) 20, 120 opening onto each of the membranes (M1; M2) 3, 103 and/or preferably an inlet of the first gas circuit (GC1) 10; 110 opening onto each of the membranes (M1; M2) 3, 103.

According to a variant, the device 1, 101 comprises at least one tubular gas-liquid separation membrane 3, 103.

According to a variant, the device comprises more than two gas-liquid separation membranes. According to a variant, the device comprises four gas-liquid separation membranes for example placed facing one another in pairs.

According to a variant, the device comprises one or more tubular membranes.

Advantageously, the internal geometry of the device is designed so as to avoid the appearance of a recirculation loop and the creation of “dead zones”, in particular in the area comprising the membrane and the element for holding the membrane in position, constituted typically by a sintered metal element, if it is present.

According to an advantageous variant, a chamfer is produced on the membrane support, said chamfer being placed facing the inlet and outlet orifice of the inert gas passing on the permeate side of the membrane so as in particular to distribute the inert gas homogeneously at the surface of the membrane, on the permeate side.

According to a variant, the membrane is held in position by a support element. The use of several membranes and in particular at least two membranes makes it possible to increase the total separation surface.

The membrane 3, 103 can comprise an active material, such as for example of the silicone type. The membrane can comprise one or more layers of gas-liquid separator material.

By way of example, the membrane can be supported on a sintered support 8, 108, which can for example be made from stainless steel or bronze. According to a variant, the membrane support has a chamfer at its edge at the level of the face opposite that in contact with the membrane.

Advantageously, the chamfer allows the inert gas originating from the first gas circuit GC1 reaching the inlet orifice 12 to be distributed homogeneously at the support surface. This variant makes it possible to ensure that the concentration of inert gas over all of the surface 32, 132 on the permeate side of the separation membrane.

According to a variant, the support 8, 108 is a porous support.

According to a variant, the membrane 3, 103 is firmly fixed (bonding, deposition, etc.) with the support 8, 108.

Sealed Casing

According to a variant, the first gas circuit 10, 110 and the second gas circuit 20, 120 are placed in a casing sealed to liquid (L), preferably able to withstand a pressure of at least 60 MPa.

According to a variant, the measurement device 50, 150 is contained in a sealed casing, and preferably in the casing sealed to liquid containing the first and the second gas circuit.

According to a variant, the reservoir 170 of inert gas can be inside or outside the envelope.

Advantageously, all of the device is sealed to liquid, and preferably to a pressurized liquid. Typically, the device is designed in order to withstand deployment in deep water such as for example the floor of an ocean, a sea or a lake.

According to an embodiment, the device according to the invention is autonomous. By “autonomous” is meant that it comprises all the elements necessary in order to analyze at least one parameter of at least one gas extracted from a liquid. In particular, the elements necessary for analyzing this parameter are the device or devices for separating at least one gas dissolved in a liquid, the liquid circulation circuit, the first and second gas circulation circuits, and the analysis (or measurement) instrument.

According to a variant, the sealed casing comprises only the device 1 for extracting the gas with the membrane and the first gas circuit 10, 110 and the second gas circuit 20, 120 are placed partly outside the casing sealed to liquid (L) containing the membrane.

Advantageously, the device 1, 101 comprises a positioning instrument in order to determine the geographical position of the device.

According to a variant, the autonomous device comprises a spatial and/or temporal positioning probe. A means of spatial positioning can be for example a radar for positioning in the water or a set of accelerometers calculating the position relative to the last known position. According to a particular embodiment, the device of the invention comprises a sounder for measuring or positioning the depth in the liquid. It is typically a sounder determining the depth in an ocean, a sea or a lake, such as for example a pressure sensor.

According to a variant, the device of the invention can be coupled with a sonar, for example in order to determine the position of the device relative to a ship.

According to a variant, the autonomous device can comprise a motorization capable of moving the device.

Thus according to a variant, the device is autonomous in order to be deployed in a terrestrial aqueous fluid, such as for example an ocean, a lake, a sea.

According to a variant, the device of the invention is in continuous or discontinuous communication with a ship.

Thus according to a variant, the device 1, 101 comprises an instrument for transmitting measured data to a remote electronic device, for example situated on a ship or a land station, and/or an instrument for receiving instructions from a remote electronic device, for example situated on a ship or a land station.

According to a variant, the extraction device of the invention can comprise a vessel for storing isotopes, such as for example of radioactive carbon, for immediate or subsequent measuring.

According to an advantageous variant, the device according to the invention is a remotely operated vehicle (ROV), or operated remotely or with autonomous control in order to complete a determined programme, such as a glider or an autonomous underwater vehicle (AUV).

According to an advantageous variant, the device according to the invention is a device arranged in fluid communication with a fluid of an industrial reactor.

Measurement Instruments

According to a variant, the measurement device is located in the same casing as the extraction device. Thus according to a variant, the invention relates to a device comprising at least one extraction device as defined according to the invention, and at least one measurement device 50, 150.

According to a variant, the measurement device is not located in the casing of the extraction device. Thus according to a variant, the invention relates to a device comprising at least one extraction device as defined according to the invention, and not comprising the measurement device. The measurement device can thus be located in a laboratory, for example.

The device or measurement instrument can by any type of instrument for measuring at least one parameter of at least one gas, and in particular the gas G_{L}. The analysis can relate to several types of gas G_{L} separated from the liquid.

Typically it is a spectrometer.

According to an embodiment, the measurement device is able to measure the partial pressure or the concentration of a gas contained in the gas stream entering the device. Typically, it is a device for measuring the partial pressure for example of an alkane compound able to be dissolved in a liquid solution, and more precisely in water, such as for example methane, ethane, any one of their isotopes, any one of their hydrates or even CO₂, carbon monoxide, hydrogen sulphide (H2S), ammonia (NH3), hydrochloric acid (HCl), hydrofluoric acid (HF), H2, O2, N2O, NO, SO2, SO3, COS, etc.

According to a variant, the measurement device is an optical spectrometer.

According to a specific variant, the measurement device is a multi-gas infra-red laser analyzer (for example OFCEAS—“optical feedback cavity enhanced spectroscopy”).

According to a variant, the measurement device 50, 150, is for example an amplified resonant absorption spectrometer, optionally arranged with a temperature regulator and/or a vacuum pump. According to a variant, the measurement device is an OFCEAS (optical feedback cavity enhanced spectroscopy) spectrometer. Such a spectrometer makes it possible to analyze multiple gases at the same time (for example methane CH4 and ethane C2H6).

According to an advantageous variant, the measurement instrument makes it possible to analyze several gases simultaneously, and for example their concentration.

According to a variant, the instrument measures one or more parameters of methane, and/or the two or more isotopes of water.

According to a variant, the measurement device analyses the presence and/or quantifies the isotopes of the dissolved gas separated from the liquid (GO.

According to a variant, an inlet of the liquid circuit (LC) 5, 105 and an inlet of the first gas circuit 10, 110 are positioned in order to maximize the contact surface area of the inert gas with the membrane 3, 103.

The liquid is advantageously pumped in a constant stream by a liquid pump and preferably the liquid flow rate is not affected by the pressure variation. Advantageously, the liquid flow rate is controlled so that the boundary layers and the turbulence at the surface of the membrane 33, 133 are minimal.

Advantageously, the measurement device comprises a temperature regulation system.

Advantageously, the measurement device carries out the measurement in a vacuum, and in particular in a vacuum created by a vacuum pump situated downstream of the measurement device.

It is preferable that the cell of the measurement device, typically a spectrometer having an optical cavity, is kept at low pressure (pressure of several tens of millibars).

The measurement instrument can be in communication with a computer 190 that is onboard or not collecting analysed or measured data. Thus, according to a variant, the measurement device is controlled by a computer 190. Advantageously, the flow rate of the stream GC1 is subtracted from the flow rate of the stream GC2, for example by the computer 190 in order to determine the concentration or the quantity of dissolved gas separated from the liquid G_{L}. The result from the analysis device 50, 150 is processed by the computer 190 in order to obtain knowledge of the parameter to be measured.

Typically the computer comprises a programme for recording, processing and visualizing the data received. Storage of the analysed or measured data can also be carried out in the autonomous device. This communication can be carried out for example via electromagnetic waves or the displacement of electrical current. Typically, a computer 190 controls the gas circuits, the measurement device, the storage of data, in particular those collected etc. Typically, when the device according to the invention is used under water, a computer communicates the data at the surface (using for example communication protocols of the ADSL, SHDSL type or via a coaxial cable, twisted pair, or optical fiber).

According to a variant, the results are produced in real time, retained and/or sent to a receiving device.

According to an advantageous variant, the device according to the invention collects the data necessary for four-dimensional visualization of the parameter or parameters of the dissolved gas or gases sought. A four-dimensional visualization can be represented by the change of one or more parameters, for example of the concentration, of a gas dissolved as a function of time, and of its position in a liquid (x,y,z).

Thus the present invention also relates to a 4D graphic (x,y,z, parameter analysed, typically the concentration) obtained by the device according to the present invention.

Measurement Method

According to another aspect, the present invention relates to a method for measuring at least one parameter, such as for example the concentration, of at least one gas dissolved in a liquid, such as for example a terrestrial aqueous fluid, said method implementing a device according to the invention in order to obtain a measurement of at least one parameter of a gas dissolved in the liquid.

The present invention relates to a method for measuring, preferably continuously, the concentration or the partial pressure of at least one gas dissolved in a liquid, said method comprising bringing a gas/liquid separation device comprising at least one membrane into contact with a liquid the concentration of at least one dissolved gas of which is to be measured, separating at least one gas dissolved in the liquid through the membrane or membranes of the gas/liquid separation device, measuring the diffusion and/or permeation stream through the membrane or membranes, and calculating the concentration or the partial pressure of the gas previously dissolved in the liquid based on the diffusion and/or permeation stream.

According to an embodiment, the concentration gradient between the gas dissolved in the liquid and the gas on the permeate side of the membrane or membranes represents the main diffusion and/or permeation force.

The present invention relates more specifically to a method for studying the concentration of a dissolved gas such as methane, carbon dioxide or other species, their isotopes or their hydrates, for example on the floor of the ocean, for the study of an area of cold seep and/or hydrothermal springs on the floor of the ocean, for the study of the ocean dynamics located by atmospheric tracers dissolved in water, for the geochemical characterization of the origin of hydrocarbons, for example at the sediment-ocean interface, for environmental surveillance of offshore oil installations, for prospecting new oil- and/or gas-rich areas on the floor of the ocean and/or water tables, for studying pollution by hydrocarbons dissolved in a water table.

The present invention relates to a method implemented with a device as defined according to the invention.

More particularly, the current of inert gas imposed by the first gas circulation circuit 10, 110 has the advantage that the concentration of gas extracted from the liquid is theoretically zero or as weak as possible at the inner surface 32, 132 of the membrane 3, 103 (permeate side). By controlling and/or measuring at least one secondary parameter which influences permeation or diffusion, the device of the invention makes it possible to access for example the concentration of gas extracted from the liquid. The concentration gradient between the gas dissolved in the liquid and the gas on the inner surface 32, 132 of the membrane 3, 103 is the main driving force for the diffusion and/or permeation. By retaining the concentration of gas extracted from the liquid on the side of the inner surface 32, 132 of the membrane 3, 103 at a theoretical value of zero or as weak as possible, and by controlling and/or measuring at least one secondary parameter with respect to the gas in question, the device according to the invention makes it possible to determine the concentration of gas dissolved in the liquid. The response time of the device according to the invention is no longer dependent on the equilibrium of both sides of the membrane, but is advantageously determined and limited by the permeation time through the membrane and the time for the sample of gas to flow in the second gas circuit 20, 120 until reaching the measurement instrument 50, 150.

By way of example, one or more, preferably all, of the secondary parameters of the gas extracted from the liquid measured and/or controlled, in particular in the context of the analysis of the concentration of a gas dissolved in saline water, are selected from the group consisting of: the liquid stream in contact with the membrane 3, 103, the salinity of the liquid, the temperature of the liquid, the temperature of the membrane, the total pressure, the concentration of one or more other dissolved gases (such as for example another gas dissolved in the liquid, for example oxygen) or one or more elements dissolved in the liquid (such as for example ions such as for example of iron) in the liquid which could have an influence on the permeation stream which must be analysed, the surface of the membrane, the composition of the inert gas, the flow rate of inert gas.

Advantageously, the use of inert gas circulating in the first gas circuit 10, 110, the stream of which is advantageously controlled by a flow control, provides control of the dilution of the sample to be analysed in order to optimize the measurement range at the sensitivity of the measurement instrument 50, 150, or to avoid saturation of the measurement instrument 50, 150.

Advantageously, the use of the inert gas circulating in the first gas circuit 10, 110 dilutes the concentration of water vapour when the gas is extracted from this liquid (water).

According to a variant, the method and the device according to the present invention make it possible to collect the gas extracted from the liquid analysed in order to collect a gas sample in one or more reservoirs. The gas sample or samples contained in the reservoir or reservoirs can then be subsequently analysed, together or separately.

Typically, the volume of gas passing into the measurement instrument and the volume of liquid in contact with the membrane 3, 103 are measured or controlled. The flow rate of inert gas is controlled by a flow controller, the total flow rate of the gas (gas extracted from the liquid and inert gas) is measured with a device for measuring the flow rate. The liquid stream is advantageously controlled as it affects the quantity of gas passing through the membrane. The prior techniques do not specifically control the liquid flow rate as it does not directly affect the measurement since the prior devices wait for equilibrium.

By means of the device of the present invention, it is possible to meet the needs of academia and industry in order for example to measure at high spatial and temporal resolution with excellent sensitivity, the concentration of methane or other dissolved gases. The technology can in particular be applied to the study of a gas of interest to the oil or gas industry, such as ethane or the isotopes of methane.

The device according to the present invention can also be applied to measuring the concentration of trace gas in the oceans, seas or lakes.

The device of the invention can be used for studying the offgassing of methane hydrate on the floor of the oceans, the fate of methane in a column of water and/or its contribution to acidification of the oceans, for example.

The device according to the present invention is useful for studying areas of cold seep and hydrothermal springs on the floor of the oceans.

The device according to the invention is useful for studying the ocean dynamics using atmospheric tracers dissolved in water, and in particular for producing spatial maps of the evolution of these atmospheric tracers dissolved in water.

The device according to the present invention is useful for geochemical characterization of the source of hydrocarbons at the sediment-ocean interface.

The device according to the present invention is also useful for environmental surveillance for example associated with the risk of leaks on offshore oil or gas installations.

The device according to the invention is also useful for prospecting new oil or gas plays, for example on the floor of the ocean.

The device according to the present invention is also useful for studying water tables, and in particular their pollution by dissolved hydrocarbons.

The device according to the present invention is more particularly useful for measuring the concentration of gas dissolved in an ocean by deploying the device in situ. It makes it possible to supply in real time the data sought.

Typically, measuring the concentration or the partial pressure of at least one dissolved gas is carried out in the context of an industrial process, for example an industrial processing or chemical reaction process and/or a process involving living matter. Thus the invention relates to a device for processing or chemical reactions and/or involving living matter comprising the extraction device defined according to the present invention.

Thus the device according to the present invention is more particularly useful for measuring the concentration of gas dissolved in an industrial reactor. In particular, the device according to the present invention is more particularly useful for measuring the concentration of gas dissolved in a bioreactor.

The invention is detailed below with regard to specific embodiments which in no way limit the scope according to the invention.

### BRIEF DESCRIPTION OF THE DRAWINGS

In the figures:

FIG. 1 diagrammatically represents an embodiment according to the invention having a double membrane.

FIG. 2 represents a longitudinal section along the section A-A of the membrane represented in FIG. 1.

FIG. 3 represents a longitudinal section along the section B-B of the membrane represented in FIG. 1.

FIG. 4 diagrammatically represents an embodiment having more specifically gas circuits utilizing two membranes in the form of discs.

FIG. 5 diagrammatically represents an embodiment having a tubular membrane.

FIG. 6 diagrammatically represents an embodiment having more specifically gas circuits utilizing a tubular membrane.

FIG. 7 represents a graph of the evolution of the concentration of methane over time comparing the measurements obtained with a probe of the prior art “prior art” and the device according to the invention “Invention”.

FIG. 8 represents a graph of the evolution of the concentration of methane over time as a function of the flow rate of liquid (water).

FIG. 9 represents the effect of the variation of the flow rate of inert gas on the measurement of the concentration of methane as a function of the total flow rate of gas.

FIG. 10 represents a diagrammatic view of the information at the input and results at the output of a computer or a microprocessor according to an embodiment example of the invention.

### DESCRIPTION OF THE PREFERRED EMBODIMENTS

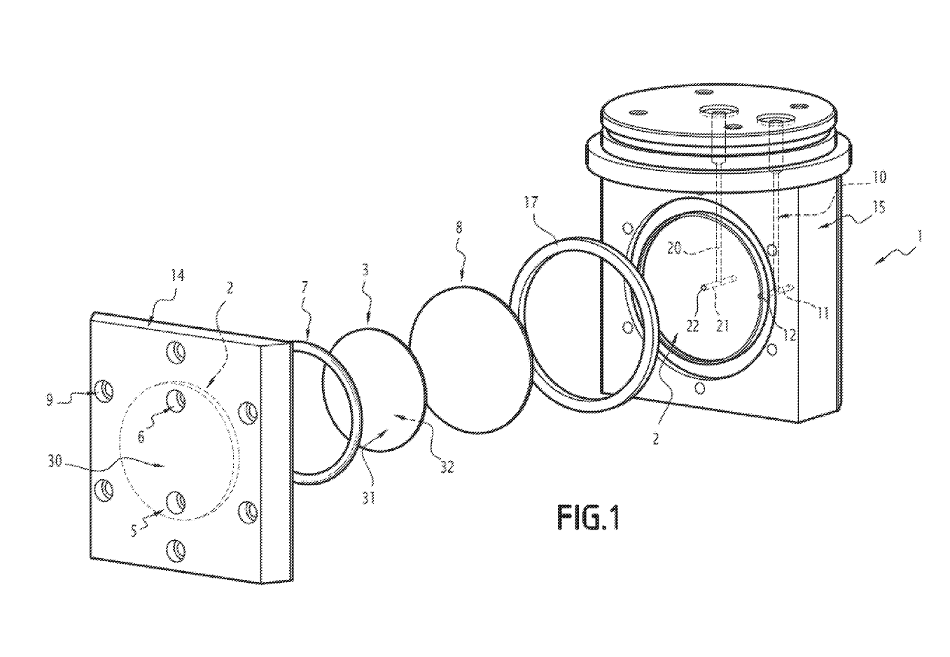

FIG. 1 shows a body 1 having, for example, a fixed part 15, a removable part 14 and at least two housings 2 for membranes 3 placed facing one another. A device according to the present invention can comprise 1, 2, 3, 4 or more membranes. With reference to FIG. 1, the arrangement of a membrane is described more specifically, the arrangement of a second membrane being substantially identical, the second membrane being situated on the opposite face of the body 1 allowing housing of the membrane. The housing 2 can be produced in the form of a recess in the fixed 15 and/or removable 14 part of the body. According to an embodiment, the removable part 14 has at least one liquid inlet orifice 5, the liquid preferably being situated outside the device and at least one outlet orifice 6 of this liquid. A seal 7 ensures the inner cavity is sealed to the surrounding liquid. Thus the liquid circulating in the liquid circulation circuit (LC) remains confined to the outside of the membrane 3. The liquid is in contact with the outer surface 31 of the membrane. The membrane 3 is capable of separating at least one gas dissolved in the liquid during contact of the liquid with the outer surface 31 of the membrane 3. Advantageously, the stream of liquid flows along a plane substantially parallel to the outer longitudinal surface of the membrane 3. The liquid flow (L) 30 can be carried out for example by means of a pump. Advantageously, the inlet 5 and outlet 6 orifices of the liquid circulation circuit are placed so as to avoid the presence of bubbles of gas such as for example air in contact with the outer surface 31 of the membrane 3. According to an embodiment, when the device is placed in a liquid volume, the inlet orifice 5 is situated in a lower part of the outlet orifice 6 of the liquid circuit. According to an embodiment, the inlet 5 and outlet 6 orifices are placed diametrically opposite or on opposite edges of the membrane 3.

According to an embodiment, the membrane 3 can be placed in contact with an element 8 for supporting the membrane 3, holding the membrane 3 in position and withstanding the pressure of the liquid. According to a variant, the membrane 3 is placed in contact with a support element 8 withstanding a high liquid pressure, such as for example when the device is deployed in a deep volume of water. Typically the element 8 for supporting the membrane 3 withstands a pressure of at least 40 Mpa, preferably 60 Mpa. According to a variant, the support element 8 comprises or is constituted by a sintered metal. Advantageously, the support element 8 has a shape similar to the shape of the membrane 3.

According to a variant, the support element 8 is in contact with the inner surface 32 of the membrane 3.

Advantageously, the support element 8 is porous to the gas or gases extracted from the liquid and to the inert gas (Gᵢ) and does not affect the gas extracted from the liquid, at least one parameter of which is to be measured.

The device comprises a first circuit 10 for circulating inert gas (Gᵢ) in contact with the inner surface 32 of the membrane 3. According to an embodiment, the first circulation circuit 10 has a pipe 11 opening onto the solid element 8 for supporting the membrane 3 so that the inert gas (Gᵢ) circulating in the first circulation pipe 10 flows through the support element 8. According to an embodiment, the pipe 11 opening onto the support element 8 is positioned substantially on the periphery of the surface of the support element 8. Typically, the pipe 11 comprises an orifice 12 in contact with the support element 8. According to an embodiment, the orifice 12 is situated facing the liquid outlet orifice 6.

Advantageously, the first circulation circuit 10 makes it possible for the inert gas to flow over substantially all of the inner surface 32 of the membrane 3. According to an advantageous embodiment, the support element 8 has a beveled edge, for example chamfered, so as to distribute the gas stream of inert gas over all of the periphery of the membrane 3 and thus create a gas stream of inert gas from the periphery of the membrane 3 (over the inner surface 32) to the second circulation circuit 20. The second circulation circuit 20 will make it possible to evacuate the inert gas in a mixture with the gas extracted from the liquid through the membrane 3. The gas dissolved in the liquid thus passes from the liquid circuit through the membrane 3, the extracted gas being driven by a differential pressure (for example created by a vacuum pump in the second circulation circuit) towards the second circulation circuit 20.

According to an embodiment, the second circulation circuit 20 has a pipe 21 opening onto the solid element 8 for supporting the membrane 3 so that the inert gas and the extracted gas in contact with the membrane are directed towards the second gas circuit 20. According to an embodiment, the pipe 21 opening onto the support element 8 is positioned substantially in the central part of the support element 8. Typically, when the membrane 3 and the support element 8 have a circular periphery, the orifice 22 of the second gas circuit is substantially placed at the centre.

According to an embodiment, the pipe 11 of the first gas circuit 10 and the pipe 21 of the second gas circuit 20 has as many orifices as the device has membranes. In a device comprising two membranes, the pipe 11 and the pipe 21 have two orifices.

Advantageously, the second gas circuit 20 is in communication with an item of equipment for analyzing at least one parameter of at least one dissolved gas contained in the gas stream circulating in the second gas pipe 20.

All of the device can be firmly fixed by fastening means 9, such as for example screws, nuts/bolts, firmly holding together the fixed part 15 and the removable part 14 of the body 1.

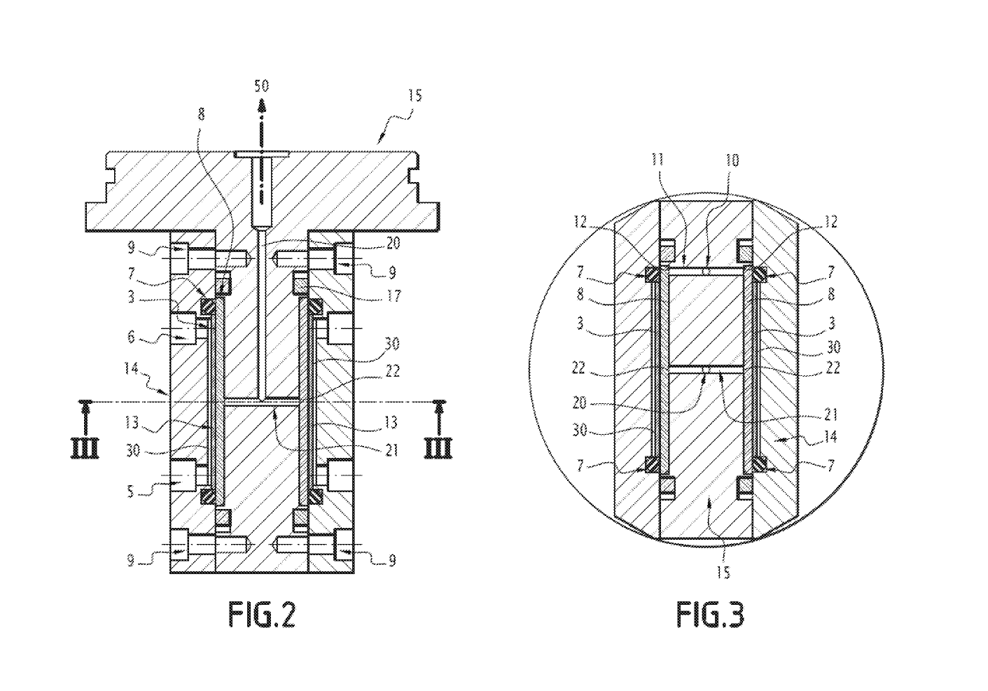

FIG. 2 represents the cross section A-A of an embodiment according to FIG. 1. This cross-section makes it possible to identify more specifically the housing 2 of the body 1 receiving the membrane 3 and the support element 8. The membrane 3 is placed on the surface of the support element 8. According to an embodiment, the support element 8 is positioned in a recess of the fixed part 15 of the body 1 and the membrane 3 is positioned at the surface of the support element 8 facing a recess of the removable part 14 of the body 1, which are firmly fixed by fastening elements 9. In FIG. 2 can be seen a space 13 forming a circulation space 30 of the liquid between the inlet 5 and outlet 6 orifices. Thus the liquid stream flows substantially parallel to the surface of the membrane 3 such that all of the surface of the membrane is in contact with the liquid circulating in the liquid circuit 30. According to this embodiment, the two support elements 8 are in connection with the second gas circuit 20, making it possible to convey the gas extracted from the liquid to a measurement device 50 (not shown). According to this embodiment, the pipe 21 opens by means of the orifices 22 onto the support elements 8. The seal 7 can be for example an O-ring housed in a recess of the removable 14 or fixed 15 part.

According to an advantageous embodiment, the device can comprise a gas-tight seal 17. Advantageously, the device operates under a pressure less than that of the surrounding environment and requires total sealing of the gas circuits. Advantageously, the gas circuits must be isolated from contact with a gas outside the device.

FIG. 3 represents the cross section B-B of the device represented in FIG. 1. In particular the first gas circuit 10 and the second circulation circuit 20 can be seen, which comprise respectively a pipe 11, 21 and orifices 12, 22 opening onto the support elements 8.

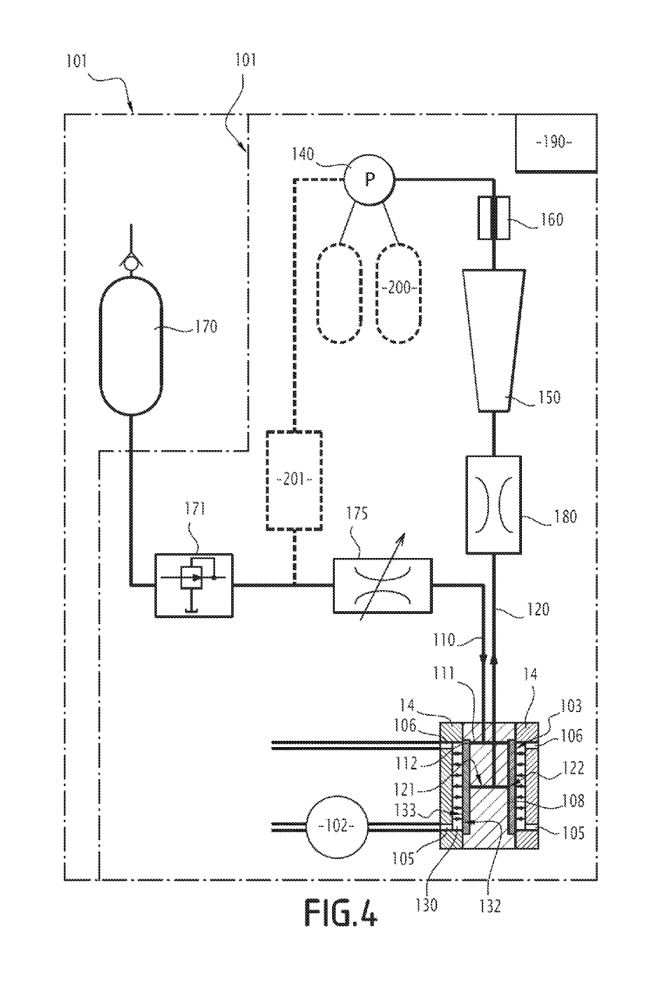

In FIG. 4 the liquid circuit 130 can be seen, comprising a liquid inlet by means of an orifice 105 and a liquid outlet by means of an orifice 106. The liquid stream in the liquid circuit 130 is in contact with a gas/liquid separation device comprising or consisting of a membrane 103 placed on a support element 108. The liquid stream in the liquid circuit 130 is more particularly in contact with the outer surface 133 of the membrane 103. For example a pump 102 is used in order to maintain a constant liquid flow rate. The first gas circuit 110 comprises a pipe 111 opening by means of the orifice 112 onto the support element 108, porous to the inert gas contained in the first gas circuit 110 so that the stream of inert gas sweeps the inner surface 132 of the membrane 103, and advantageously over a maximum surface area of the inner surface 132 of the membrane. According to an embodiment, the inert gas can be contained in a reservoir 170, situated for example outside or inside the body 101 shown here diagrammatically by a dotted line. The inert gas can advantageously be circulated by a pressurized pump or reservoir, for example the reservoir 170. The pressure can be for example from 30 to 40 bar. Advantageously, the first gas circuit 110 comprises a pressure reducing valve 171, for example bringing the pressure to approximately 1.5 bar(a) (absolute pressure). The pressure of the inert gas Gᵢ is reduced by a pressure reducing valve 171 to an operating pressure of the flow controller 175.

According to an advantageous embodiment, the first gas circuit 110 comprises a gas stream controller 175 making it possible to control the flow rate of the gas stream in the first gas circuit 110.

The second gas circuit 120 advantageously comprises a vacuum pump 140 making it possible to ensure the circulation of the gas stream comprising the gas extracted from the liquid in the second gas circuit 120. According to a variant, the gas is pumped through the measurement device 150 and stored in a reservoir 200. According to a variant, the gas is pumped through the measurement device 150 and purified in a device 201 for purifying the inert gas and returned to the first gas circuit GC1.

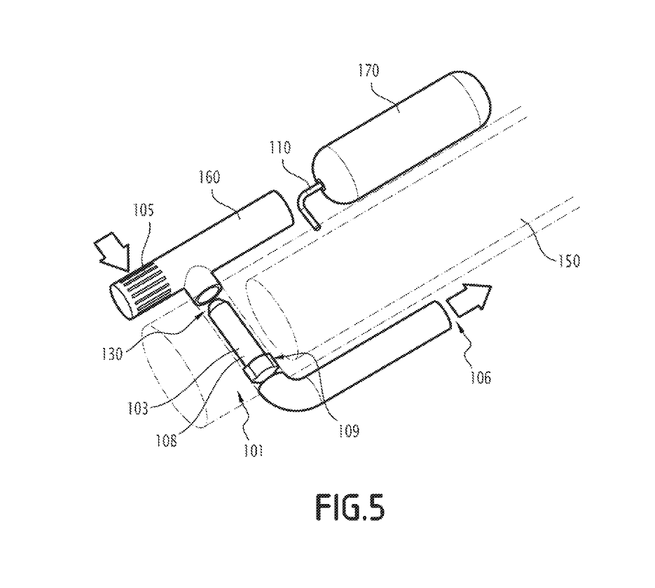

FIG. 5 represents an embodiment different from FIG. 1, utilizing a membrane 103 that is tubular in shape. The device comprises a liquid pump 160, typically a water pump, remote from the body 101 advantageously forming a housing for at least one instrument 150 for measuring at least one parameter of at least one gas to be analyzed and to be extracted from the liquid. The liquid pump 160 is housed in the vessel comprising one or more inlet orifices 105 of a liquid stream. The liquid pump 160 circulates the liquid in the liquid circuit 110, the liquid circuit 110 opening onto an outlet orifice 106 ejecting the liquid from the body of the device 101. According to an embodiment, the outlet orifice 106 is placed opposite the inlet orifice 105, and preferably close to the inner diameter of the membrane seal so that the surface of contact of the liquid stream with the surface of the membrane 33, 133 is maximized for extraction of dissolved gas through the membrane. Advantageously, the outlet orifice 106 is arranged and positioned in order to minimize a pressure change effect on the flow rate of the stream passing through the membrane 133.

A tubular membrane 3 is held in place by means of one or more fastening elements 109. The tubular membrane 103 can be deposited on a support element 108 porous to the gas to be extracted from the liquid, typically produced from sintered metal.

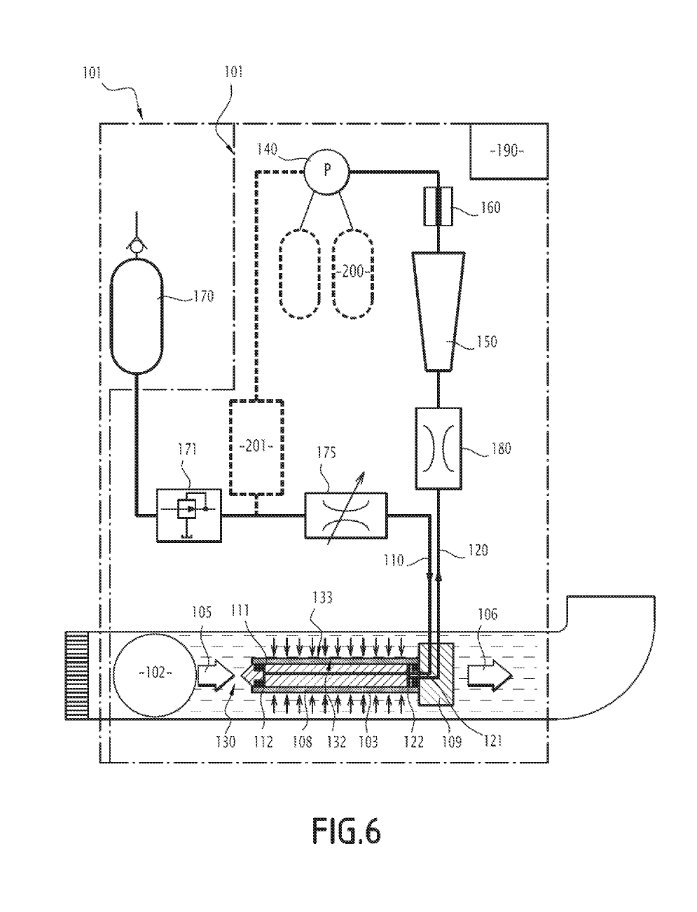

The device has an inert gas vessel 170 remote from the body 101 making it possible for the inert gas to flow in the first gas circuit 120. FIG. 5 does not give details of the gas circulation circuit. An example of the gas circulation circuit can be seen more accurately in FIG. 6.

In FIG. 6 the liquid circuit 130 can be seen, comprising a liquid inlet by means of an orifice 105 and a liquid outlet by means of an orifice 106. The liquid stream in the liquid circuit 130 is in contact with a gas/liquid separation device comprising a membrane 103 placed on a support element 108 which is fastened by a fastening element 109. The liquid stream in the liquid circuit 130 is more particularly in contact with the outer surface 133 of the membrane 103. The first gas circuit 110 comprises a pipe 111 opening by means of the orifice 112 onto the support element 108, porous to the inert gas contained in the first gas circuit 110 so that the stream of inert gas sweeps the inner surface 132 of the membrane 103, and advantageously over a maximum surface area of the inner surface 132 of the membrane. According to an embodiment, the inert gas can be contained in a reservoir 170, situated for example outside or inside the body 101. The inert gas can advantageously be circulated by a pressurized pump or reservoir, for example the reservoir 170. The pressure can be for example from 30 to 40 bar. Advantageously, the first gas circuit 110 comprises a pressure reducing valve 171, for example bringing the pressure to approximately 1.5 bar(a). According to an advantageous embodiment, the first gas circuit 110 comprises a gas stream controller 175 making it possible to control the flow rate of the gas stream in the first gas circuit 110.

According to an embodiment, the second gas circuit 120 comprises a device for measuring the gas stream 180. The second gas circuit 120 advantageously comprises a vacuum pump 140 making it possible to ensure the circulation of the gas stream in the second gas circuit 120. According to a variant, the gas of the second gas circuit GC2 is purified in a purification device 201 and the inert gas Gᵢ present in the second gas circuit GC2 is returned to the first gas circuit GC1.

Advantageously, the device for measuring the gas stream 180 is in communication with at least one measurement instrument 150. Typically, the measurement instrument 150 is a spectrometer. According to a particular embodiment, the measurement instrument 150 is a gas analyzer, for example based on a laser infra-red absorption spectroscopy technique.

The following examples present embodiments of the present invention:

### Example 1: Analysis of the Concentration of Methane in an Ocean

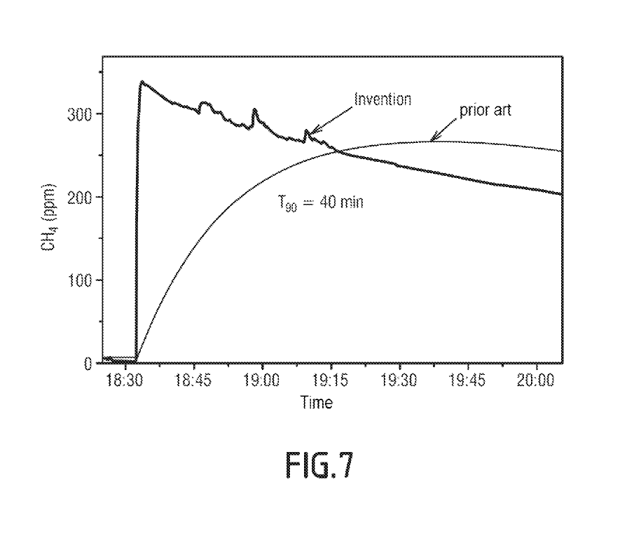

FIG. 7 shows comparative results obtained with the device of the invention and a device according to the prior art. The instruments were both placed in a water reservoir of approximately 15 L with an atmospheric concentration of dissolved methane of approximately 2 ppm (parts per million). At approximately 18 h30, a portion of water (approximately 500 ml) enriched with methane was added to the water reservoir. In FIG. 7, it is noted that the instrument according to the invention makes it possible to provide a response on the methane concentration almost immediately (approximately 15 seconds response time), unlike the probe of the prior art (“prior art”) which requires more than 40 minutes without being able to provide the real measurement of the methane content. In fact, the signal is smoothed by the long response time of the instrument. Thus according to the prior device, it is not possible to know the initial maximum concentration of methane in the water.

### Example 2: Effect of the Flow Rate of Water

The effect of the flow rate of water on the analysis carried out for example by a device described above with reference to FIG. 1 was studied. The inlet of the liquid, here water, containing dissolved methane was brought into communication with a reservoir containing water and the dissolved gas in order to draw the liquid through the device according to the invention.

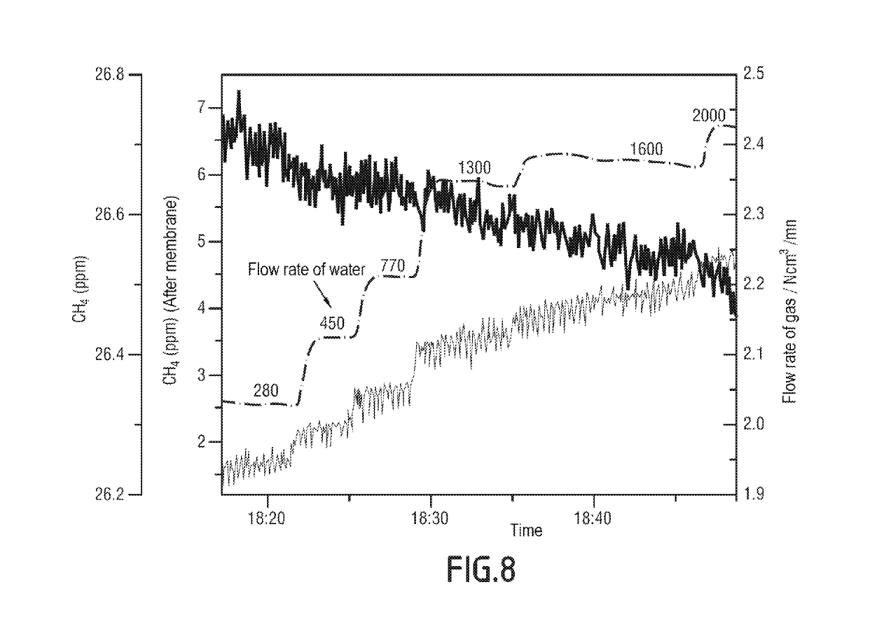

Table 1 below and FIG. 8 show the data and the results obtained.

| Reservoir parameters | | | | Flow rate of water (ml/min) | | | | | | | | | | | |
|---|---|---|---|---|---|---|---|---|---|---|---|---|---|---|---|
| Flow rate of | | | CH4 | 280 | | 450 | | 770 | | 1300 | | 1600 | | 2000 | |
| gas | Temperature | Pressure | Conc | | Flow | | Flow | | Flow | | Flow | | Flow | | Flow |
| Ncm³/mn | ° C. | mbar(a) | ppm | Conc | rate | Conc | rate | Conc | rate | Conc | rate | Conc | rate | Conc | rate |
| 100 | 25 | 1003 | 3 | 0.56 | 1.6 | 0.75 | 1.63 | 0.97 | 1.675 | 1.4 | 1.73 | 1.55 | 1.75 | 1.69 | 1.78 |
| 100 | 25 | 1003 | 8 | 1.34 | 1.64 | 2 | 1.69 | 2.4 | 1.72 | 3.24 | 1.77 | 3.5 | 1.81 | 3.85 | 1.83 |
| 100 | 25 | 1003 | 15 | 2.5 | 1.74 | 2.75 | 1.78 | 3.3 | 1.85 | 4.2 | 1.91 | 4.7 | 1.925 | 5.2 | 1.94 |
| 100 | 25 | 1003 | 30 | 2.55 | 1.94 | 3.57 | 2 | 4.48 | 2.05 | 5.85 | 2.13 | 6.3 | 2.2 | 6.75 | 2.24 |

The concentrations (Conc) are expressed in ppm and the flow rates in Ncm³/mn.

### Example 3: Effect of the Flow Rate of Inert Gas

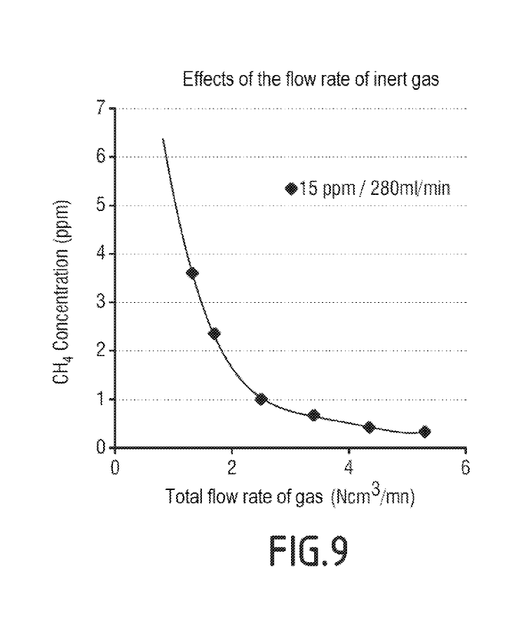

FIG. 9 represents an example of the effect of the variation of the flow rate of inert gas on measuring the concentration of methane as a function of the total flow rate of gas. The measurement is carried out for a liquid comprising a concentration of 15 ppm methane. This diagram shows that the flow rate of the gas stream needs to be well controlled and accurately measured. When the flow rate of the inert gas is zero, it is not possible to obtain the methane concentration. When the flow rate of inert gas increases, it is possible to measure the methane concentration. The flow rate of gas analyzed by the measurement device can vary by adjusting the flow rate of inert gas. The greater the flow rate of inert gas, the more the methane is diluted in the total gas stream. This shows the benefit of diluting a gas sample with the inert gas. For example, if the concentration of gas to be measured (here methane) was 1000 ppm in the liquid, it would be necessary to dilute this gas with the inert gas in order to avoid saturating the measurement device.

Concentration of methane in the reservoir: 15 ppm
Flow rate of water: 280 ml/min
Flow rate of extracted gas (approx.) 0.2 Ncm³/mn

TABLE 2

| Total flow | |
|---|---|
| rate of gas | CH4 Conc |
| Ncm³/mn | ppm |
| 1 | response too |
| | long |
| 1.32 | 3.6 |
| 1.7 | 2.35 |
| 2.5 | 1 |
| 3.4 | 0.67 |
| 4.35 | 0.42 |
| 5.3 | 0.33 |

### Example 4: Flow Chart for Processing by a Computer

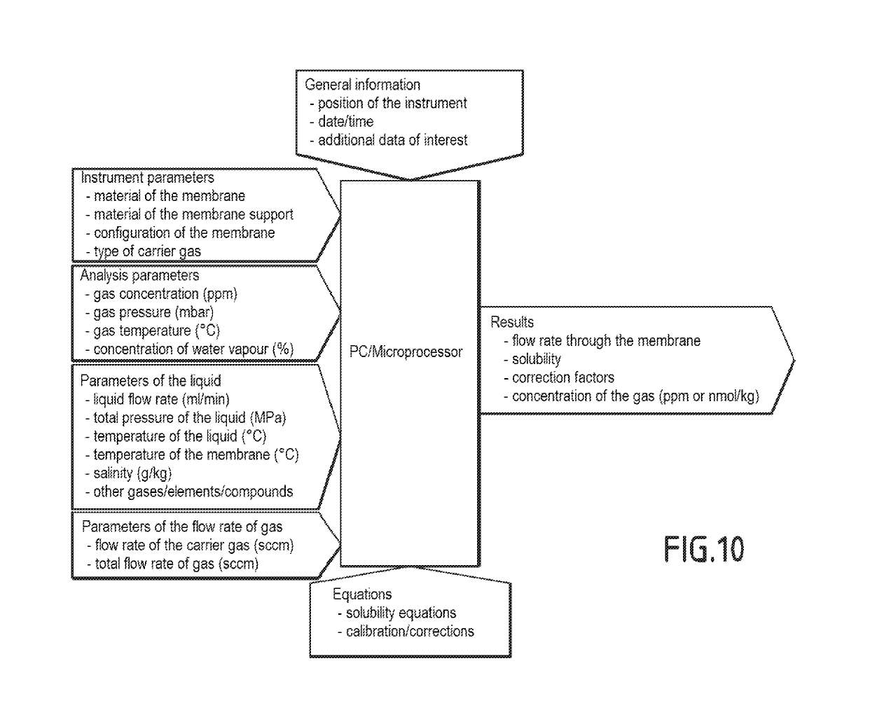

FIG. 10 shows an example of a flow chart for processing by a computer or a microprocessor in which is given as input information for example:
the material of the membrane, the material of the membrane support, the configuration of the membrane, the type of carrier gas;
the analysis parameters, such as for example the gas concentration (ppm), the gas pressure (mbar), the gas temperature (° C.), the concentration of water vapour (%);
the parameters of the liquid, such as for example the liquid flow rate (ml/min), the total pressure of the liquid (MPa), the temperature of the liquid (° C.), the temperature of the membrane (° C.), the salinity (g/kg), the presence of other gases, elements or compounds;
the parameters of the flow rate of gas, such as for example the flow rate of the carrier gas (Ncm³/mn), the total flow rate of gas (Ncm³/mn);
general information, such as for example the position of the instrument, the date and the time, any additional data of interest;
the equations, such as for example solubility equations, the calibration parameters and any corrections;

The computer obtains results at the outlet, such as for example:
the flow rate through the membrane;
the solubility;
the correction factors;
the concentration of the gas separated from the liquid (ppm or nmol/kg).

1. Device (1, 101) for extracting at least one gas dissolved in a liquid, said device comprising (i) at least one gas-liquid separation membrane (3, 103), (ii) at least one liquid circuit (LC) (5, 105) for at least one liquid (L) comprising a dissolved gas, said liquid circuit (LC) (5, 105) being arranged in order to bring the liquid (L) into contact with at least one gas-liquid separation membrane (3, 103), the liquid being in contact with the outer surface (31, 133) of the membrane (3, 103), (iii) a first gas circuit (GC1) (10, 110) for circulating at least one inert gas (Gᵢ), the first gas circuit (GC1) being in contact with the inner surface (32, 132) of the membrane (3, 103), the first circuit (GC1) (10, 110) not comprising gas (G_{L}) separated from the liquid (L) upstream of the membrane (3, 103), and (iv) a second gas circuit (GC2) (20, 120) for circulating inert gas (Gᵢ) and at least one gas (G_{L}) separated from the liquid (L), the second circuit (GC2) (20, 120) being in contact with the inner surface (32, 132) of the membrane (3, 103) and communicating with the first gas circuit (GC1) (10, 110), the second gas circuit (GC2) (20, 120) circulating at least one gas (G_{L}) separated from the liquid to a device (50, 150) for measuring at least one parameter of the gas (G_{L}) separated from the liquid.

2. Device according to claim 1, wherein the first gas circuit (10, 110) comprises a gas stream regulator (175), for example in the form of a pressure regulator and/or a gas flow rate regulation device, advantageously optimizing the response time and the concentration of the gas (G_{L}) separated from the liquid (L) at least one parameter of which is to be measured in the measurement device (50, 150).

3. Device according to claim 1, wherein the second gas circuit (20, 120) comprises a device for measuring the gas stream (180) for example in the form of a device for measuring pressure and/or a device for measuring the flow rate of gas, advantageously making it possible to know or estimate the flow rate of gas extracted from at least one parameter to be measured in the measurement device (50, 150).

4. Device according to claim 1, wherein the second gas circuit (1, 120) comprises a device for driving (140) the gas (G_{L}) separated from the liquid, for example a pump.

5. Device according to claim 1, wherein the device (1, 101) comprises at least two gas-liquid separation membranes (M1; M2) (3, 103) placed facing one another.

6. Device according to claim 1, wherein the device (1, 101) comprises returning the inert gas (Gᵢ) from the second gas circuit (GC2) to the first gas circuit (GC1), preventing or limiting the circulation of gas (G_{L}) separated from the liquid in the first gas circuit (GC1).

7. Device according to claim 1, further comprising a device for maintaining a zero or insignificant concentration at the surface of the membrane or membranes on the permeate side and one or more control and/or measurement devices of at least one secondary parameter, significantly influencing the permeation and/or the diffusion through the membrane or membranes.

8. Device, comprising at least one extraction device as defined according to claim 1, the device comprising at least one measurement device (50, 150), and for example an amplified resonant absorption spectrometer.

9. Device according to claim 1, wherein the device (1, 101) is autonomous in order to be deployed in an aqueous terrestrial fluid.

10. Device according to claim 1, wherein the device (1, 101) comprises a positioning instrument in order to determine the geographical position of the device.

11. Device according to claim 1, wherein the device (1, 101) comprises an instrument for transmitting measured data to a remote electronic device, for example situated on a ship or a land station, and/or an instrument for receiving instructions from a remote electronic device, for example situated on a ship or a land station.

12. Method for measuring the concentration or the partial pressure of at least one gas dissolved in a liquid, said method comprising bringing a gas/liquid separation device comprising at least one membrane into contact with a liquid the concentration of at least one dissolved gas of which is to be measured, the separation of at least one gas dissolved in the liquid through the membrane or membranes of the gas/liquid separation device, measuring the diffusion and/or permeation stream through the membrane or membranes, and calculating the concentration or the partial pressure of the gas previously dissolved in the liquid based on the diffusion and/or permeation stream.

13. Method according to claim 12, wherein the method is implemented with a device for extracting at least one gas dissolved in a liquid, said device comprising (i) at least one gas-liquid separation membrane (3, 103), (ii) at least one liquid circuit (LC) (5, 105) for at least one liquid (L) comprising a dissolved gas, said liquid circuit (LC) (5, 105) being arranged in order to bring the liquid (L) into contact with at least one gas-liquid separation membrane (3, 103), the liquid being in contact with the outer surface (31, 133) of the membrane (3, 103), (iii) a first gas circuit (GC1) (10, 110) for circulating at least one inert gas (Gᵢ), the first gas circuit (GC1) being in contact with the inner surface (32, 132) of the membrane (3, 103), the first circuit (GC1) (10, 110) not comprising gas (G_{L}) separated from the liquid (L) upstream of the membrane (3, 103), and (iv) a second gas circuit (GC2) (20, 120) for circulating inert gas (Gᵢ) and at least one gas (G_{L}) separated from the liquid (L), the second circuit (GC2) (20, 120) being in contact with the inner surface (32, 132) of the membrane (3, 103) and communicating with the first gas circuit (GC1) (10, 110), the second gas circuit (GC2) (20, 120) circulating at least one gas (G_{L}) separated from the liquid to a device (50, 150) for measuring at least one parameter of the gas (G_{L}) separated from the liquid.

14. Method, according to claim 12, wherein measuring the diffusion and/or permeation stream through the membrane or membranes is carried out by maintaining a zero or insignificant concentration at the surface of the membrane or membranes on the permeate side, causing a stream of inert gas to pass over the surface, said stream of inert gas flowing in an open circuit.

15. Method according to claim 12, wherein measuring the concentration or the partial pressure of at least one dissolved gas by means of a measurement device (50, 150) is carried out by subtracting the value of the inert gas flow rate from the value of the total flow rate of gas sent to the measurement device (50, 150).

16. The method according to claim 12, wherein the method is performed to study the concentration of a dissolved gas, for the study of an area of cold seep and/or hydrothermal springs on the floor of the ocean, for the study of the ocean dynamics located by atmospheric tracers dissolved in water, for the geochemical characterization of the source of hydrocarbons, for environmental surveillance of offshore oil installations, for prospecting new oil- and/or gas-rich areas on the floor of the ocean and/or water tables, for the studying pollution by hydrocarbons dissolved in a water table, or in the context of an industrial process, for an industrial processing or chemical reaction process and/or a process involving living matter.

17. The device of claim 5, wherein an inlet of the second gas circuit (GC2) (20, 120) opening onto each of the membranes (M1; M2) (3, 103) and/or an inlet of the first gas circuit (GC1) (10, 110) opening onto each of the membranes (M1; M2) (3, 103).

18. The device of claim 5, wherein the device (1, 101) comprises at least one tubular gas-liquid separation membrane (3, 103).

19. The device of claim 6, further comprising a trap for the gas (G_{L}), that is separated from the liquid, or a device for the separation of the gas (G_{L}) separated from the liquid of the inert gas (Gᵢ).

20. Device according to claim 1, further comprising a device for maintaining a zero or insignificant concentration at the surface of the membrane or membranes on the permeate side and one or more control and/or measurement devices of all of the secondary parameters, significantly influencing the permeation and/or the diffusion through the membrane or membranes.
